(19) United States
(12) Patent Application Publication
(10) Pub. No.: US 2017/0069324 A1
(43) Pub. Date: Mar. 9, 2017

(54) VOICE CONTROLLED ELECTRONIC KITCHEN ASSISTANCE

(71) Applicant: General Electric Company, Schenectady, NY (US)

(72) Inventors: William Everette Gardner, Louisville, KY (US); Christopher George Bissig, Louisville, KY (US)

(21) Appl. No.: 14/847,309

(22) Filed: Sep. 8, 2015

(51) Int. Cl. G10L 15/24; G10L 15/22; H04L 12/28

(52) U.S. Cl. CPC G10L 15/24; H04L 12/282; G10L 15/22; G10L 2015/223

(57) ABSTRACT

A method for providing electronic assistance to a user within a kitchen is provided. The method may include continuously sensing for user input voice command, receiving a trigger input in response to an action by a user within the kitchen, and receiving a user input voice command from the user. The method may then interpret the received user input voice command in light of the received trigger input to more accurately determine the substance of the user input voice command and, for example, respond accordingly if appropriate.

### FIELD OF THE INVENTION

The present subject matter relates generally to a system for providing electronic assistance to a user in a kitchen, and a method for providing the same.

### BACKGROUND OF THE INVENTION

Consumers have long kept grocery lists to remind them of items needed to be purchased at a grocery store. For example, some consumers keep a grocery list attached to an outside surface of a refrigerator appliance in the consumer's kitchen. Such a system for remembering items to be purchased at the grocery store, however, can be cumbersome and inefficient. For example, such a system requires the consumer to physically write down each item they wish to add to the grocery list. Additionally, with such a system, the consumer may forget a physical copy of the grocery list when they go to the grocery store.

Mobile telephone applications and other electronic device applications have been developed to assist consumers with keeping electronic versions of their grocery lists. Typically, these applications require the consumer to manually enter the items they need to purchase at the grocery store by physically entering such items through a user interface of their mobile telephone or other electronic device. Accordingly, is not uncommon for a consumer to forgo the step of physically entering such items, thus rendering the electronic applications ineffective.

Dedicated electronic devices have also been developed that allow a user to record items to be added to their grocery list. Such dedicated electronic devices are typically mounted within, e.g., the consumer's kitchen and are configured to record the consumer's grocery list in response to the consumer manually initiating such functionality. The dedicated electronic devices can then provide the consumer with an audio file including their recorded grocery lists items.

However, each of the above systems can be cumbersome to a consumer, reducing a likelihood that the consumer will utilize such systems. Accordingly, a more user-friendly system for providing electronic assistance within a kitchen would be useful. More specifically, a more user-friendly system for accurately receiving one or more user input voice commands would be particularly beneficial.

### BRIEF DESCRIPTION OF THE INVENTION

Aspects and advantages of the invention will be set forth in part in the following description, or may be apparent from the description, or may be learned through practice of the invention.

In an exemplary aspect of the present disclosure, a method for providing electronic assistance to a user in a kitchen is provided. The method includes continuously sensing for a user input voice command through one or more microphones configured to receive audio inputs within the kitchen. The method also includes receiving a trigger input in response to an action by the user within the kitchen. The method also includes receiving a user input voice command from the user in the form of an audio input through the one or more microphones. The method also includes interpreting the received user input voice command in light of the received trigger input.

In an exemplary embodiment of the present disclosure, a system for providing electronic assistance to a user in a kitchen is provided. The system includes one or more microphones for receiving audio inputs within the kitchen and one or more triggers configured to receive a trigger input in response to an action by the user within the kitchen. The system also includes a controller operably connected to the one or more microphones and the one or more triggers. The controller is configured to continuously sense for a user input voice command in the form of an audio input through the one or more microphones. The controller is further configured to receive a trigger input from the one or more triggers, and to receive a user input voice command from the user in the form of an audio input through the one or more microphones. Additionally, the controller is configured to interpret the received user input voice command in light of the received trigger input.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a kitchen according to an exemplary embodiment of the present subject matter.

FIG. 2 provides a top view of the exemplary kitchen of FIG. 1.

FIG. 3 provides a schematic view of an exemplary computer-based system according to an exemplary embodiment present disclosure.

FIG. 4 provides a flow diagram of a method for providing electronic assistance to a user in a kitchen in accordance with an exemplary aspect of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

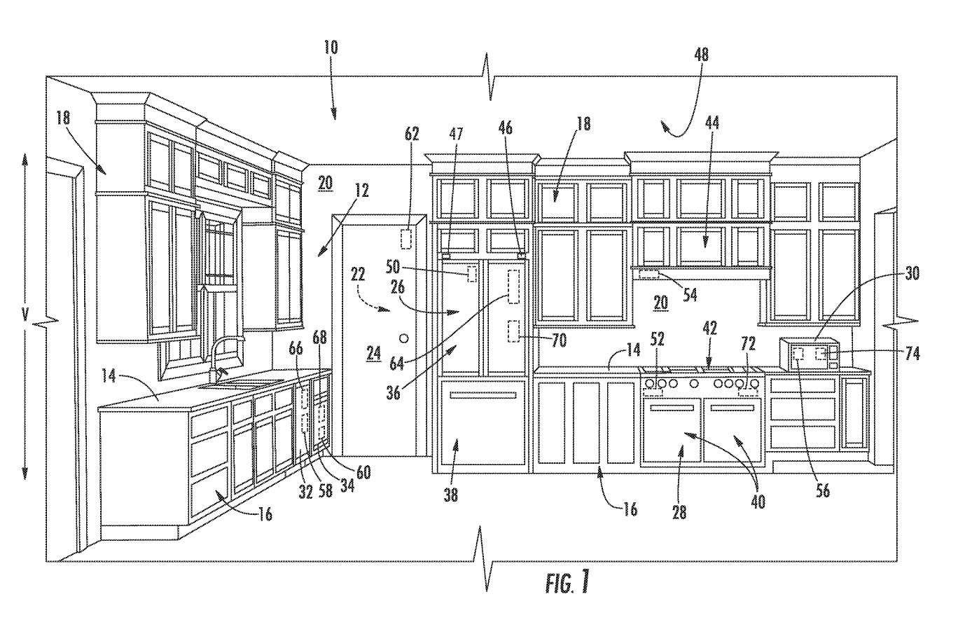

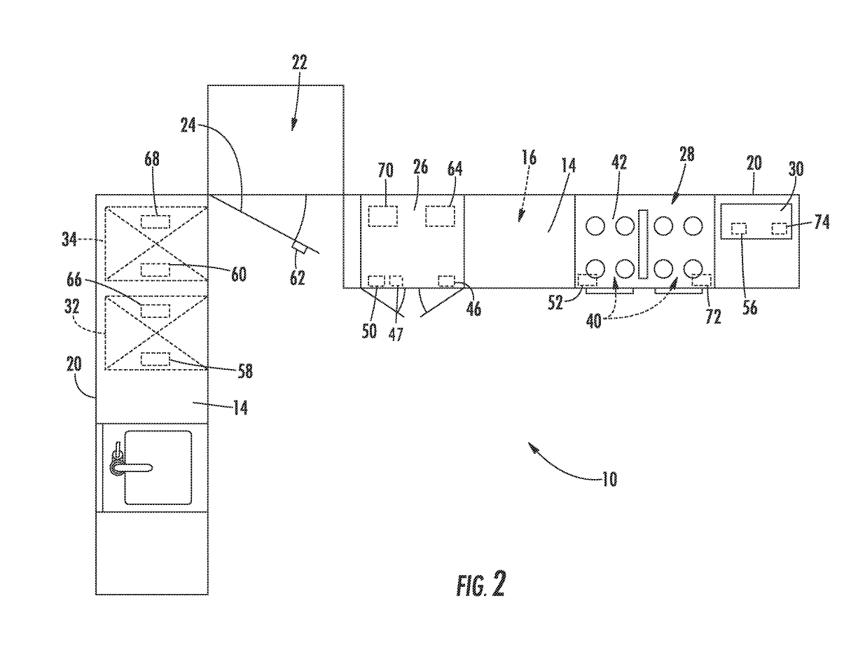

FIG. 1 provides a perspective view of a kitchen 10 including a system for providing electronic assistance in accordance with an exemplary embodiment of the present disclosure. FIG. 2 provides a top, schematic view of the exemplary kitchen 10 of FIG. 1. As is depicted, the kitchen 10 generally includes a plurality of cabinets 12, one or more countertops 14, and a variety of kitchen appliances. The plurality of cabinets 12 depicted includes bottom mount cabinets 16 and top mount cabinets 18.

The one or more countertops 14 are mounted atop the bottom mount cabinets 16, with the top mount cabinets 18 mounted, e.g., to a wall 20 above the countertops 14 along a vertical direction V. Although not depicted, the exemplary kitchen 10 includes a cupboard 22 (in phantom) accessible through a cupboard door 24. The top and bottom mount cabinets 16, 18 and the cupboard 22 may be used to store food items, kitchen utensils, and/or other items.

Additionally, for the exemplary kitchen 10 depicted, the variety of kitchen appliances includes a refrigerator appliance 26, an oven appliance 28, a microwave appliance 30, a dishwashing appliance 32, and a trash compacting appliance 34. Specifically, the exemplary refrigerator appliance 26 is configured as a bottom mount refrigerator appliance having a refrigerator portion 36 accessible to a user through a pair of french refrigerator doors, and a freezer portion 38 accessible to a user through a sliding freezer door. Additionally, the exemplary oven appliance 28 includes side-by-side mounted ovens 40 and a gas range 42 positioned on top of the side-by-side ovens 40. A hood or vent 44 is, for the embodiment depicted, integrated into the top mount cabinets 18 and positioned directly above the range 42 of the oven appliance 28 along the vertical direction V. The vent 44 may capture cooking exhaust gases when a user is cooking with the oven appliance 28. Additionally, the exemplary microwave appliance 30 depicted is positioned directly on the countertop 14. However, in other embodiments, the kitchen 10 may include the microwave appliance 30 mounted within and/or enclosed within the top or bottom mount cabinets 16, 18. Moreover, the exemplary dishwashing appliance 32 and trash compacting appliance 34 are mounted below the countertop 14, integrated into the plurality of bottom mount cabinets 16.

It should be appreciated, however, that the exemplary kitchen 10 and appliances depicted in FIGS. 1 and 2 are provided by way of example only. In other exemplary embodiments, the kitchen 10 may have any other suitable layout and may include additional kitchen appliances not described herein, and/or may not include one or more of the kitchen appliances described herein. Further, in other embodiments, the kitchen appliances depicted may have any other suitable configuration.

As stated above, the exemplary kitchen 10 of FIGS. 1 and 2 also includes a system for providing electronic assistance to a user within the kitchen 10. The system generally includes one or more microphones for receiving audio inputs within the kitchen 10 and one or more triggers configured to receive a trigger input in response to an action by the user within the kitchen 10. Specifically, for the embodiment depicted, the exemplary system includes a single microphone 46 mounted to a top portion of the refrigerator appliance 26. The microphone 46 may be configured to receive a user input voice command from a user positioned anywhere within the kitchen 10 in the form of an audio input. Additionally, a speaker 47 is also provided, mounted adjacent to the microphone 46 on the refrigerator appliance 36. The speaker 47 may be configured to play an audio signal, e.g., as a response to a received user input voice command. It should be appreciated, however, that although for the embodiment depicted the single microphone 46 and the single speaker 47 are included, mounted to a top portion of the refrigerator appliance 26, in other exemplary embodiments any other suitable number and/or position of microphones and speakers may be included. For example, in other exemplary embodiments, the exemplary system may include a plurality of microphones and/or speakers spaced throughout the kitchen 10. Additionally, or alternatively, the exemplary system may include one or more microphones and/or speakers mounted on or integrated into various of the other kitchen appliances, one or more of the plurality of bottom or top mount cabinets 16, 18, and/or other structural components of the kitchen 10 (e.g., a ceiling 48, walls 20, etc.).

Referring still to FIGS. 1 and 2, the one or more triggers of the exemplary system include a plurality of triggers positioned throughout the kitchen 10. For example, at least certain of the plurality of triggers are mounted on or integrated into one or more of the kitchen appliances. Particularly for the embodiment depicted, the one or more triggers include the following triggers mounted on or integrated into the kitchen appliances: a refrigerator trigger 50 associated with the refrigerator appliance 26, an oven trigger 52 associated with the oven appliance 28, a vent trigger 54 associated with the vent 44, a microwave trigger 56 associated with the microwave appliance 30, a dishwasher trigger 58 associated with the dishwashing appliance 32, and a trash compactor trigger 60 associated with the trash compacting appliance 34. Additionally, the one or more triggers include a cupboard trigger 62 associated with the cupboard door 24.

In certain exemplary embodiments, one or more of the triggers may each include a sensor. For example, one or more of the plurality of triggers may include a motion sensor for detecting the presence of a user proximate to an associated appliance. For example, the refrigerator trigger 50 may include a motion sensor for detecting the presence of the user proximate to the refrigerator appliance 26. Similarly, the dishwasher trigger 58 may include a motion sensor for detecting the presence of the user proximate to the dishwashing appliance 32; the cupboard trigger 62 may include a motion sensor for detecting the presence of the user proximate to the cupboard door 24; the oven trigger 52 and/or vent trigger 54 may each include a motion sensor for detecting the presence of a user proximate the oven appliance 28; and the microwave trigger 56 may include a motion sensor for detecting the presence of the user proximate the mark with appliance.

Additionally, or alternatively, the one or more triggers may include a sensor configured to determine whether a door of an associated kitchen appliance and/or cupboard 22 is in an open position or a closed position (i.e., a “door open” sensor). For example, the dishwasher trigger 58 may include a door open sensor configured to determine whether or not a door of the dishwashing appliance 32 is in an open position or a closed position (as shown). Similarly, the trash compactor sensor may include a door open sensor configured to determine whether or not a door of the trash compactor is in an open position or a closed position (as shown); the cupboard trigger 62 may include a door open sensor configured to determine whether the cupboard door 24 is in an open position or a closed position (as shown); the refrigerator trigger 50 may include an open door sensor configured to determine whether or not a door of the refrigerator appliance 26 is in an open position or a closed position (as shown); the oven trigger 52 may include an open door sensor configured to determine whether one or more of the doors of the oven appliance 28 is in an open position or a closed position (as shown); and the microwave trigger 56 may include a door open sensor configured to determine whether a door of the microwave appliance 30 is in an open position or a closed position (as shown). For example, in only certain exemplary embodiments, the door open sensor may include one or more of an accelerometer sensor, a proximity sensor (such as a magnetic sensor), or any other suitable sensor for determining whether or not a door is in an open and closed position.

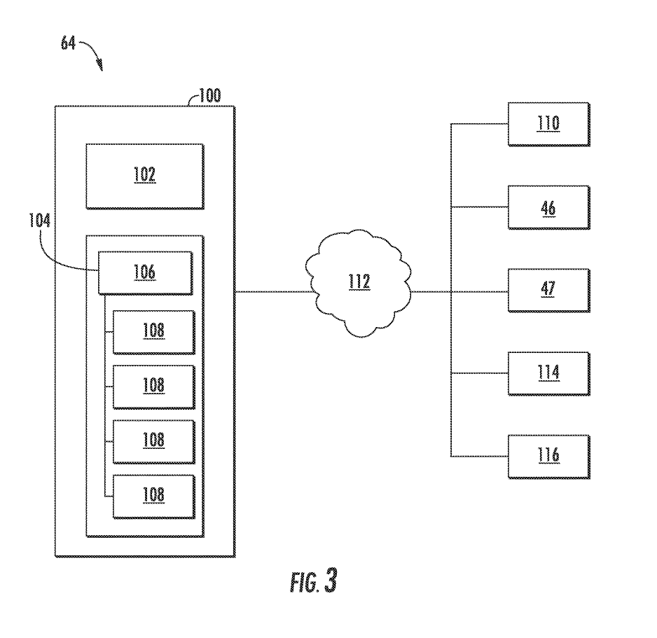

Referring now also to FIG. 3, depicting an exemplary computer-based system according to an exemplary embodiment present disclosure, the exemplary system includes a controller 64. The controller 64 is operably connected to the one or more microphones, the one or more triggers, and the one or more speakers of the system.

For the embodiment depicted, the exemplary system is configured as a computer-based system and the controller 64 includes a computing device 100 having one or more processor(s) 102 and associated memory device(s) 104. The computing device 100 is configured to perform a variety of computer-implemented functions to control the exemplary system of FIGS. 1 and 2. The computing device 100 can include a general purpose computer or a special purpose computer, or any other suitable computing device. It should be appreciated, that as used herein, the processor 102 may refer to a controller, a microcontroller, a microcomputer, a programmable logic controller (PLC), an application specific integrated circuit, and other programmable circuits. Additionally, the memory device(s) 104 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD), and/or other suitable memory elements. The memory 104 can store information accessible by processor(s) 102, including instructions that can be executed by processor(s) 102. For example, the instructions can be software or any set of instructions that when executed by the processor(s) 102, cause the processor(s) 102 to perform operations. For the embodiment depicted, the instructions include a voice recognition software 106 and a plurality of individual voice recognition software domains 108, each individual domain 108 accessible by the voice-recognition software 106. Alternatively, the individual voice recognition software domains 108 may be included within the voice-recognition software 106.

In certain embodiments, the controller 64 (and computing device 100) may be wirelessly connected to at least one of the microphone 46, one or more of the triggers (indicated generally as numeral 110 in FIG. 3), and/or the speaker 47. For example, the controller 64 including the computing device 100 may be wirelessly connected to the microphone 46, the speaker 47, and/or one or more of the plurality of triggers 110 through a wireless communications network 112. For example, in certain exemplary embodiments, the controller 64 may be wirelessly connected to the microphone 46, speaker 47, and/or one or more of the plurality of triggers 110 using a wireless sensor network (such as a Bluetooth communication network), a wireless local area network (WLAN), a point-to point communication networks (such as radio frequency identification networks, near field communications networks, etc.), or a combination of two or more of the above communications networks. With such an exemplary embodiment, one or more of the triggers may be configured as self-contained “pucks” that may be mounted to an appliance by a user and paired to the controller 64. For example, each puck may contain one or more sensors, a battery, and hardware/software for wirelessly connecting to the controller 64 through the wireless communications network 112.

It should be appreciated, however, that in other exemplary embodiments, one or more of the microphone(s), speaker(s), and/or triggers may alternatively be operably connected to the controller 64 in any other suitable manner. For example, in certain exemplary embodiments, one or more of the microphone(s) (such as microphone 46), speaker(s) (such as speaker 47) and/or triggers may be operably connected to the controller 64 via one or more electrical wires of a wired communication bus.

Referring back to FIGS. 1 and 2, it should be appreciated that at least certain of the various kitchen appliances may also include a controller (separate from or integrated with the controller 64 of the system), with each of the respective controllers configured to control one or more operations of a respective kitchen appliance. For example, a controller 66 of the dishwashing appliance 32 may control washing operations of the dishwashing appliance 32; a controller 68 of the trash compacting appliance 34 may control compacting operations of the trash compacting appliance 34; a controller 70 of the refrigerator appliance 26 may control, e.g., a temperature within the refrigerator appliance 26; a controller 72 of the oven appliance 28 may control temperature settings of the various burners of the range 42 and of the ovens 40; and a controller 74 of the microwave appliance 30 may control cooking operations of the microwave appliance 30.

Further, the controller 64 of the exemplary system may additionally be operably connected to the controllers of one or more of the kitchen appliances. For example, the controller 64 of the exemplary system may be operably connected to e.g., the controller 70 of the refrigerator appliance 26, the controller 72 of the oven appliance 28, the controller 74 of the microwave appliance 30, the controller 66 of the dishwashing appliance 32, and/or the controller 68 of the trash compacting appliance 34. Accordingly, in certain exemplary embodiments, as will be discussed below, the controller 64 of the exemplary system may be capable of controlling operation of one or more of the kitchen appliances.

Furthermore, the controller 64 of the exemplary system may further be in communication with one or more electrical devices of a user (not shown). For example, in certain exemplary embodiments, the controller 64 of the exemplary system may be in communication with a mobile telephone of the user (such as a smartphone), a tablet of the user, a mobile computer of the user, etc. via one or more wireless communication networks.

Notably, the controller 64 (including the computing device 100) may be operably connected to the controllers of the various kitchen appliances (referred to generally as numeral 114) through the wireless communication network 112 depicted in FIG. 3. Similarly, the controller (including the computing device 100) may be in communication with the one or more electrical devices of a user (referred to generally as numeral 116) also through the wireless communication network 112 depicted in FIG. 3. Alternatively, however, the exemplary system may be connected to the controllers 114 of the various kitchen appliances and/or the one or more electrical devices 116 of the user in any other suitable manner.

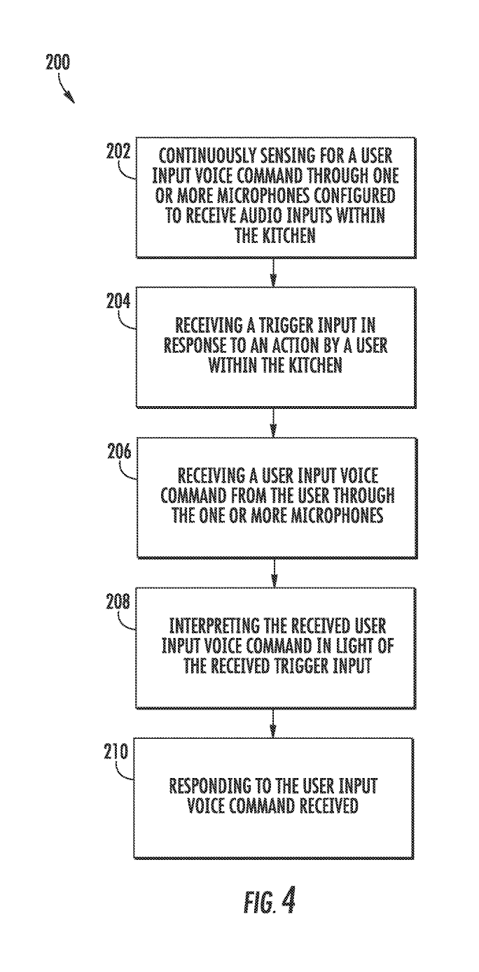

As will be discussed in greater detail below with reference to FIG. 4, the controller 64 of the exemplary system may be configured to operate the exemplary system to provide electrical assistance to the user. For example, the controller 64 of the system may be configured to continuously sense for a user input voice command through the microphone 46, receive a trigger input from the one or more triggers, receive a user input voice command from the user through the microphone 46, and interpret the received user input voice command in light of the received trigger input (e.g., using a voice recognition software). Such a configuration may accordingly allow a user to utilize the system without manually initiating a particular functionality. For example, with such a configuration, the user may simply speak a command without having to press any buttons to initiate a listening function of the system.

Additionally, in certain exemplary embodiments, in interpreting the received user input voice command in light of the received trigger input, the controller 64 may be configured to determine a domain setup for interpreting the received user input voice command. As used herein, the term “domain” in the context of interpreting speech, such as user input voice commands, refers generally to a set of rules or other speech recognition protocols that bias interpretation of such speech in light of an assumption that such speech is related to a certain category.

Further, in other exemplary aspects, the controller 64 may also be configured to respond to the received user input voice command, and in responding to the received user input voice command, the controller 64 may further be configured to, e.g., control a kitchen appliance or provide the user with an audible answer/response. By way of example, the following paragraphs illustrate potential operations of the exemplary system of FIG. 1.

### Example 1

The controller 64 continuously senses for a user input voice command through the microphone 46. While continuously sensing for a user input voice command, the controller 64 receives a trigger input from the refrigerator trigger 50 indicative of the user being positioned adjacent to the refrigerator appliance 26. For example, if the refrigerator trigger 50 includes a motion sensor, such trigger input may be a detection of user motion proximate to the refrigerator appliance 26. Additionally, or alternatively, if the refrigerator trigger 50 includes a door open sensor, such trigger input may be a detection of a door of the refrigerator appliance 26 being in an open position. The controller 64 may then sense/receive a user input voice command from the user through the microphone 46. In response to the user input voice command, and in light of the trigger input indicating the user is positioned proximate to the refrigerator appliance 26, the controller 64 may interpret the user input voice command using a “refrigerator appliance domain” of a voice recognition software. The refrigerator appliance domain may interpret unclear words or commands based on the assumption that the user is using the refrigerator appliance 26. For example, in response to a user input voice command of: “Need milk”, the controller 64 may assume the user input voice command corresponds to: “Add milk to my current grocery list.” Additionally, in response to such user input voice command, the controller 64 may be configured to transcribe of the contents for the grocery list and add such contents to an electronic grocery list.

### Example 2

The controller 64 continuously senses for user input voice command through the microphone 46. While continuously sensing for the user input voice command, the controller 64 senses a trigger input from the oven trigger 52 indicative of the user being positioned adjacent to the oven appliance 28. For example, if the oven trigger 52 includes a motion sensor, such trigger input may be a detection of user motion proximate to the oven appliance 28. Alternatively, if the oven trigger 52 includes a door open sensor, such trigger input may be a detection of a door of the oven appliance 28 being in an open position. The controller 64 may then sense/receive a user input voice command from the user through the microphone 46. In response to user input voice command, and in light of trigger input indicating the user is positioned proximate to and potentially using the oven appliance 28, the controller 64 may interpret the user input voice command using an “oven appliance domain” of a voice recognition software. The oven appliance domain may interpret unclear words or commands based on the assumption that the user is using the oven appliance 28. For example, in response to a user input voice command of: “Temperature to fry an egg”, the controller 64 may assume the user input voice command corresponds to: “What is the appropriate temperature setting to fry an egg?” Additionally, in response to such user input voice command the controller 64 may be configured to, e.g., respond with an audible response through the speaker 47 indicating to the user an appropriate temperature setting for the burners of the range 42 of the oven appliance 28 to fry an egg, and/or respond by controlling the oven appliance 28 to modify a temperature setting of one of the burners to the appropriate temperature setting for such burner to fry an egg.

Referring now to FIG. 4, a flow diagram is provided of a method (200) for providing electronic assistance to a user in a kitchen. In certain exemplary aspects, the exemplary method (200) may utilize the exemplary system described above with reference to FIGS. 1 and 2, including the computing device 100 described above with service to FIG. 3.

The exemplary method (200) includes at (202) continuously sensing for a user input voice command through one or more microphones configured to receive audio inputs within the kitchen. The one or more microphones may be positioned at any suitable location within the kitchen. For example in certain exemplary aspects, the one or more microphones may be mounted on, or integrated into, one or more of a plurality of kitchen appliances within the kitchen or one or more structural components of the kitchen (e.g., walls, ceilings, etc.).

The exemplary method (200) also includes at (204) receiving a trigger input in response to an action by a user within the kitchen. In at least certain exemplary aspects, receiving the trigger input at (204) includes receiving a trigger input from one or more triggers, the trigger input from the one or more triggers indicative of the user being engaged with (e.g., using) or positioned adjacent to a particular kitchen appliance. For example, the trigger input received at (204) may be indicative of a user's position within the kitchen, e.g., via one or more triggers including motion sensors. Additionally, or alternatively, the trigger input received at (204) may be indicative of a particular kitchen appliance being utilized by the user, e.g., via one or more triggers including door open sensors.

Referring still to the exemplary method (200), the method (200) additionally includes at (206) receiving a user input voice command in the form of an audio input through the one or more microphones, and at (208) interpreting the user input voice command received at (206) in light of the trigger input received at (204). Notably, interpreting the user input voice command at (208) may include utilizing any suitable voice recognition software.

In at least certain exemplary aspects, interpreting at (208) the user input voice command received at (206) in light of the trigger input received at (204) includes determining a domain set up for interpreting the received user input voice command based on the received trigger input. For example, the domain setup may refer to a subset of rules or other interpretation protocols within the voice recognition software, or accessible to the voice recognition software, configured to interpret a user input voice command based on certain assumptions. Wherein, for example, receiving the trigger input at (204) includes receiving a trigger input indicative of the user being engaged with a particular kitchen appliance, determining the domain set up may include selecting a domain associated with the particular kitchen appliance. Specifically, for example, if a trigger input received at (204) indicates that a user is engaged with a refrigerator appliance within the kitchen, the exemplary method (200) may determine that the domain set up should be a refrigerator appliance domain, such that a voice recognition software interprets any received user input voice commands in light of the assumption that the user is utilizing the refrigerator appliance. Continuing with this example, if a user input voice command were received at (206) and the domain set up was determined to be a refrigerator appliance domain, any unclear words or commands within the user input voice command received at (206) would be interpreted based on the assumption that the user is utilizing the refrigerator appliance.

Referring still to the exemplary method (200), the method (200) further includes at (210) responding to the user input voice command received at (206) and interpreted at (208). In at least certain exemplary aspects, responding to the received user input voice command at (210) may include controlling a kitchen appliance and/or providing the user with an audible response or answer through a speaker. For example, responding to the received user input voice command at (210) may include, based on the particular user input voice command, setting a timer on a microwave appliance, modifying a temperature setting of the oven appliance, controlling a vent positioned over an oven appliance, initiating a washing operation of a dishwasher appliance, initiating a compacting operation of a trash compactor appliance, etc. Additionally, or alternatively, wherein, for example, the user input voice command received at (206) includes receiving a user input voice command indicative of grocery list items (e.g., adding items to a grocery list, starting a grocery list, etc.), responding to the user input voice command at (210) may include transcribing the user input voice command indicative of the grocery list items. For example, a user may state as a user input voice command: “Add eggs, milk, and bread to my grocery list.” In response, the exemplary method (200) may transcribe the individual items “eggs,” “milk,” and “bread,” and add such individual items to a current grocery list.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for providing electronic assistance to a user in a kitchen, the method comprising:
continuously sensing for a user input voice command through one or more microphones configured to receive audio inputs within the kitchen;
receiving a trigger input in response to an action by the user within the kitchen;
receiving a user input voice command from the user in the form of an audio input through the one or more microphones; and
interpreting the received user input voice command in light of the received trigger input.

2. The method of claim 1, wherein interpreting the received user input voice command in light of the received trigger input includes determining a domain setup for interpreting the received user input voice command based on the received trigger input.

3. The method of claim 2, wherein receiving a trigger input includes receiving a trigger input indicative of the user being engaged with a kitchen appliance, and wherein determining the domain setup includes selecting a domain setup associated with the kitchen appliance.

4. The method of claim 1, wherein receiving a trigger input includes receiving a trigger input from one or more triggers.

5. The method of claim 4, wherein the one or more triggers include one or more motion sensors.

6. The method of claim 5, wherein the one or more motion sensors include at least one motion sensor integrated into in a kitchen appliance.

7. The method of claim 4, wherein the one or more triggers include door open sensors to determine when a door of a kitchen appliance is open.

8. The method of claim 4, wherein the one or more triggers are in wireless communication with a controller, and wherein the one or more microphones are also in wireless communication with the controller.

9. The method of claim 1, further comprising responding to the received user input voice command.

10. The method of claim 9, wherein responding to the received user input voice command includes controlling a kitchen appliance.

11. The method of claim 10, wherein receiving a user input voice command through the one or more microphones includes receiving a user input voice command indicative of one or more grocery list items, and wherein responding to the received user input voice command includes transcribing the user input voice command indicative of the one or more grocery list items.

12. A system for providing electronic assistance to a user in a kitchen, the system comprising:
one or more microphones for receiving audio inputs within the kitchen;
one or more triggers configured to receive a trigger input in response to an action by the user within the kitchen; and
a controller operably connected to the one or more microphones and the one or more triggers, the controller configured to
continuously sense for a user input voice command in the form of an audio input through the one or more microphones;
receive a trigger input from the one or more triggers;
receive a user input voice command from the user in the form of an audio input through the one or more microphones; and
interpret the received user input voice command in light of the received trigger input.

13. The system of claim 12, wherein the controller is wirelessly connected to at least one of the one or more microphones and to at least one of the one or more triggers.

14. The system of claim 12, wherein the one or more triggers includes a plurality of triggers positioned on or integrated into one or more kitchen appliances.

15. The system of claim 12, wherein in interpreting the received user input voice command in light of the received trigger input, the controller is configured to determine a domain setup for interpreting the received user input voice command.

16. The system of claim 12, wherein the one or more triggers include one or more motion sensors.

17. The system of claim 16, wherein the one or more motion sensors include at least one motion sensor attached to or integrated into in a kitchen appliance.

18. The system of claim 12, wherein the one or more triggers include one or more door open sensors to determine when a door of a kitchen appliance is open.

19. The system of claim 12, wherein the controller is further configured to respond to the received user input voice command.

20. The system of claim 19, wherein in responding to the received user input voice command the controller is configured to control a kitchen appliance.
